(19) United States
(12) Patent Application Publication
(10) Pub. No.: US 2014/0320879 A1
(43) Pub. Date: Oct. 30, 2014

(54) PRINTER DRIVER SETTING PRINTING PROGRAM AND SETTING PRINTING METHOD

(71) Applicants: KABUSHIKI KAISHA TOSHIBA, Tokyo (JP); TOSHIBA TEC KABUSHIKI KAISHA, Tokyo (JP)

(72) Inventors: Norifumi Yagi, Tokyo-to (JP); Mamoru Nomura, Tokyo-to (JP)

(73) Assignees: KABUSHIKI KAISHA TOSHIBA, Tokyo (JP); TOSHIBA TEC KABUSHIKI KAISHA, Tokyo (JP)

(21) Appl. No.: 14/261,587

(22) Filed: Apr. 25, 2014

(30) Foreign Application Priority Data
Apr. 30, 2013 (JP) 2013-095325

(51) Int. Cl. G06F 3/12

(52) U.S. Cl. CPC G06F 3/1228; G06F 3/1203; G06F 3/1232
USPC 358/1.13

(57) ABSTRACT

In accordance with one embodiment, there is provided a printer driver setting printing program which pre-sets a display name of printing for each of a plurality of printer drivers which carry out printing, and carries out, when one of the display names of printing is selected to execute printing, printing using the printer driver which is pre-set in association with the selected display name of printing.

### CROSS-REFERENCE TO RELATED APPLICATION

This application is based upon and claims the benefit of priority from Japanese Patent Application No. 2013-095325, filed Apr. 30, 2013, the entire contents of which are incorporated herein by reference.

### FIELD

Embodiments described herein relate to a printer driver setting printing program and a setting printing method.

### BACKGROUND

In a case of printing, for example, a document created in a personal computer using a printer, a printer driver corresponding to the printer is selected. Generally, as the number of used printers is limited, the printer driver set in the initial setting is used to print.

However, if the documents to be printed are of various types such as simplex printing, duplex printing, high resolution printing, color printing, erasable printing and the like, it is necessary to separately use the printers to print the documents. There also exists a case where it is necessary to change the printer driver even for the same printer.

In this case, it is necessary to select the printer or printer driver according to the types of the document to be printed. However, there is a case where a user does not know or forgets the corresponding printer driver when selecting the type of the document to be printed; even if the user knows the corresponding printer driver, it is complicated to carry out a selection operation every time.

### BRIEF DESCRIPTION OF THE DRAWINGS

FIG. 1 is a diagram illustrating an example of the constitution according to one embodiment;

FIG. 2 is a diagram illustrating an example of the constitution of a switching module according to the embodiment;

FIG. 3 is a diagram illustrating the operation of a printing setting mode according to the embodiment;

FIG. 4 is a diagram illustrating the operation of a printing mode according to the embodiment;

FIG. 5 is a diagram illustrating one example of the display of a switching tool icon on a screen of a display input section according to the embodiment;

FIG. 6 is a diagram illustrating one example of the display when the switching tool icon on the screen of the display input section according to the embodiment is clicked;

FIG. 7 is a diagram illustrating an example of a display screen in a setting mode in the embodiment; and

FIG. 8 is a diagram illustrating an example of a display screen in a printing mode in the embodiment.

### DETAILED DESCRIPTION

In accordance with one embodiment, there is provided a printer driver setting printing program which pre-sets a display name of printing for each of a plurality of printer drivers which carry out printing, and carries out, when one of the display names of printing is selected to execute printing, printing using the printer driver which is pre-set in association with the selected display name of printing.

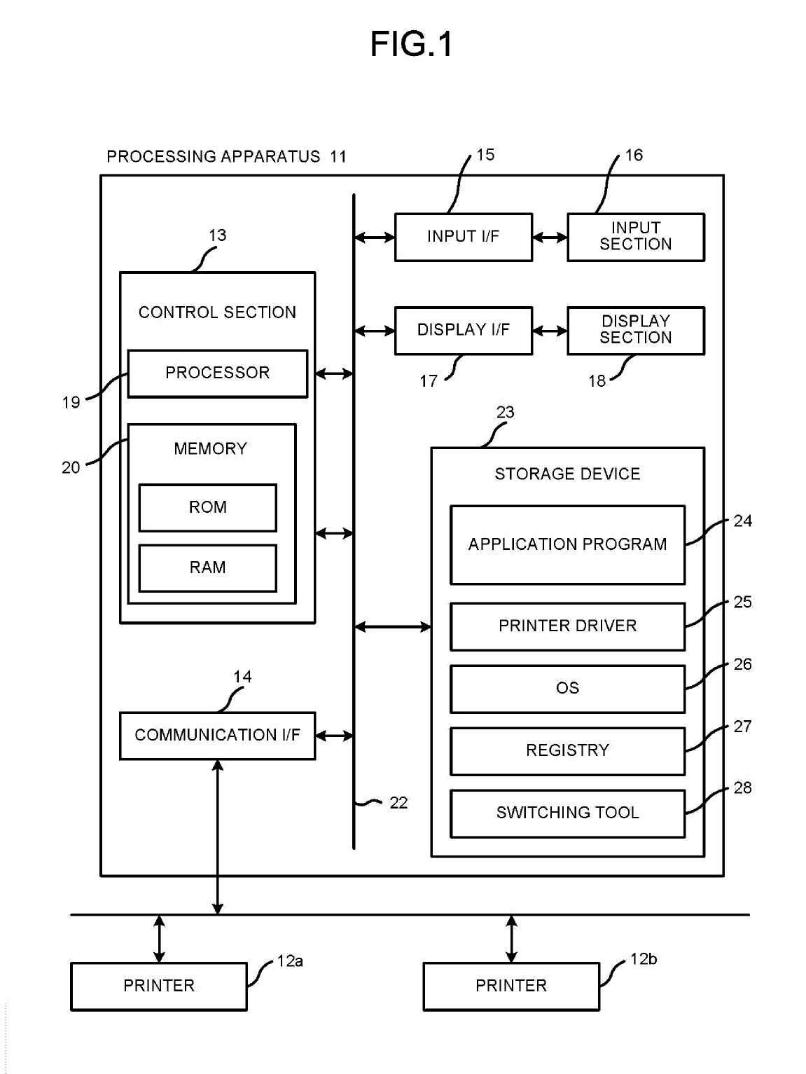

The embodiment is described below. The constitution of a processing apparatus 11 which is used when carrying out printing processing is shown in FIG. 1.

In FIG. 1, the processing apparatus 11 and a plurality of printers (two printers 12a and 12b in FIG. 1) are connected with each other through a bidirectional interface.

The processing apparatus 11 includes software, hardware, or a proper combination of the software and hardware for executing communication with the printers 12a and 12b. The processing apparatus 11 further includes a Web browser or other proper interface such as a dedicated application and the like for interacting with various Web pages and device pages and the like.

The processing apparatus 11 comprises a control section 13, a communication interface (communication I/F) 14, an input interface (input I/F) 15, an input section 16, a display interface (display I/F) 17 and a display section 18. A PC (Personal Computer) may be used as the processing apparatus 11.

The control section 13 functions through a processor 19, a memory 20 and an operating system (OS), and the processor 19 includes a CPU (Central Processing Unit) or a MPU (Micro Processing Unit). The control section 13 executes document processing on documents in which graph, image, character and table are mixed. The memory 20, which is, for example, a semiconductor memory, includes a ROM (Read Only Memory) for storing control programs of the processor and a RAM (Random Access Memory) for providing a temporary work area for the processor 19. Each component of the processing apparatus 11 is connected with each other through a bus line 22.

A storage device 23 stores an application program 24, a printer driver 25, an OS 26 serving as the control program of the processor 19, a registry 27 serving as a database of the setting information used by the OS 26 and a switching tool 28 which will be described later.

The application program 24 operates as the software of the OS 26. The application program 24 further includes a Web application, in addition to the general software. The printer driver 25, which is a device driver for controlling the printers 12a and 12b according to a printing instruction from the application program 24, operates as the software of the OS 26.

The printer driver 25 is generally selected from a printing dialog of the application program 24 and started. The setting of detailed printing condition is carried out through a property dialog of the printer driver 25.

The storage device 23 may be, for example, a hard disk drive or other magnetic storage device, an optical storage device, a semiconductor storage device such as a flash memory and the like, or any combination of these.

The communication I/F 14 is an interface connected with an external device. The communication I/F 14 communicates with the printers via a bidirectional interface 130 through a proper wireless or wired communication based on IEEE802.15, IEEE802.11, IEEE802.3 and IEEE4 such as Bluetooth (registered trademark), infrared ray connection and optical connection. The communication I/F 14 may also include a USB connection section connected with a connection terminal of a USB standard and a parallel interface and the like.

The control section 13 communicates with the printers 12a and 12b, the USE device and other external device through the communication I/F 14.

The input I/F 15 is connected with the input section 16. As the input section 16, a keyboard device or a mouse may be used as a man-machine interface.

The display I/F 17 is connected with the display section 18. The display I/F 17 receives data or an instruction to be displayed on the display section 18 from other components connected with the bus line 22. The display I/F 17 outputs display data to the display section 18. For example, a display accompanying the PC may be used as the display section 18.

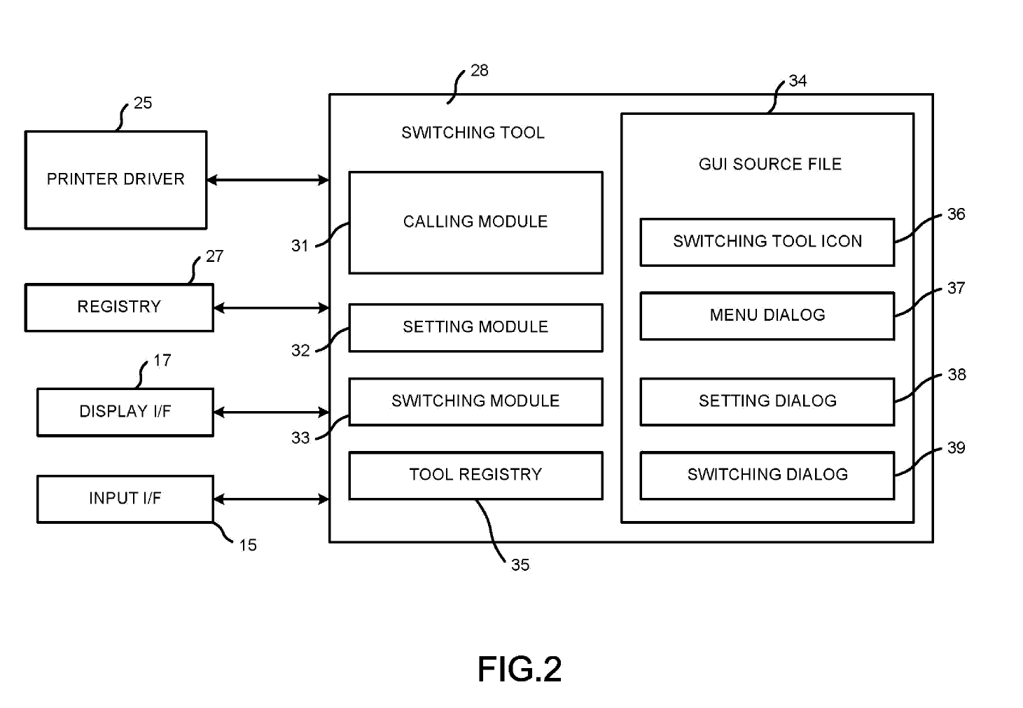

One example of the constitution of the switching tool 28 is shown in FIG. 2. Each module shown in FIG. 2 is defined as a program, and the switching tool 28 operates as the software of the OS 26. The switching tool 28, after being installed in the storage device 23 of the processing apparatus 11, is controlled by the control section 13.

The switching tool 28 includes a printer driver calling module 31, a setting module 32, a switching module 33, a graphic user interface (GUI) source file 34 and a tool registry 35.

The GUI source file 34 comprises a switching tool icon 36, a menu dialog 37, a setting dialog 38 and a switching dialog 39.

The switching tool 28 displays each screen of the GUI source file 34 on the display section 18 through the control section 13 of the processing apparatus 11. The switching tool 28 acquires input information through the input I/F 15 and the display I/F 17.

The printer driver calling module 31 calls the printer driver 25 installed in the storage device 23, and then displays the printer driver 25 on the display section 18. The setting module 32 executes various setting of the switching tool 28, and writes the set information in the tool registry 35. The switching module 33 calls the setting information from the tool registry 35 and executes a switching processing which will be described later.

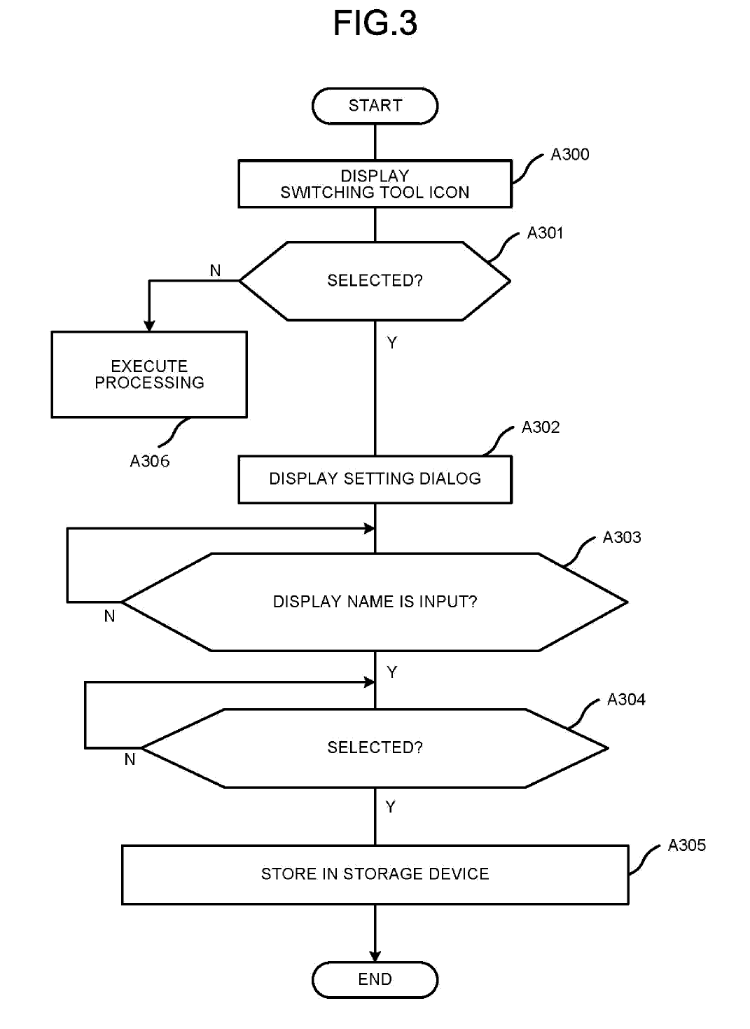

First, the setting processing of the switching tool 28 is described with reference to the flowchart shown in FIG. 3. When the switching tool 28 is started, the control section 13 displays the switching tool icon on the display section 18 (ACT A300).

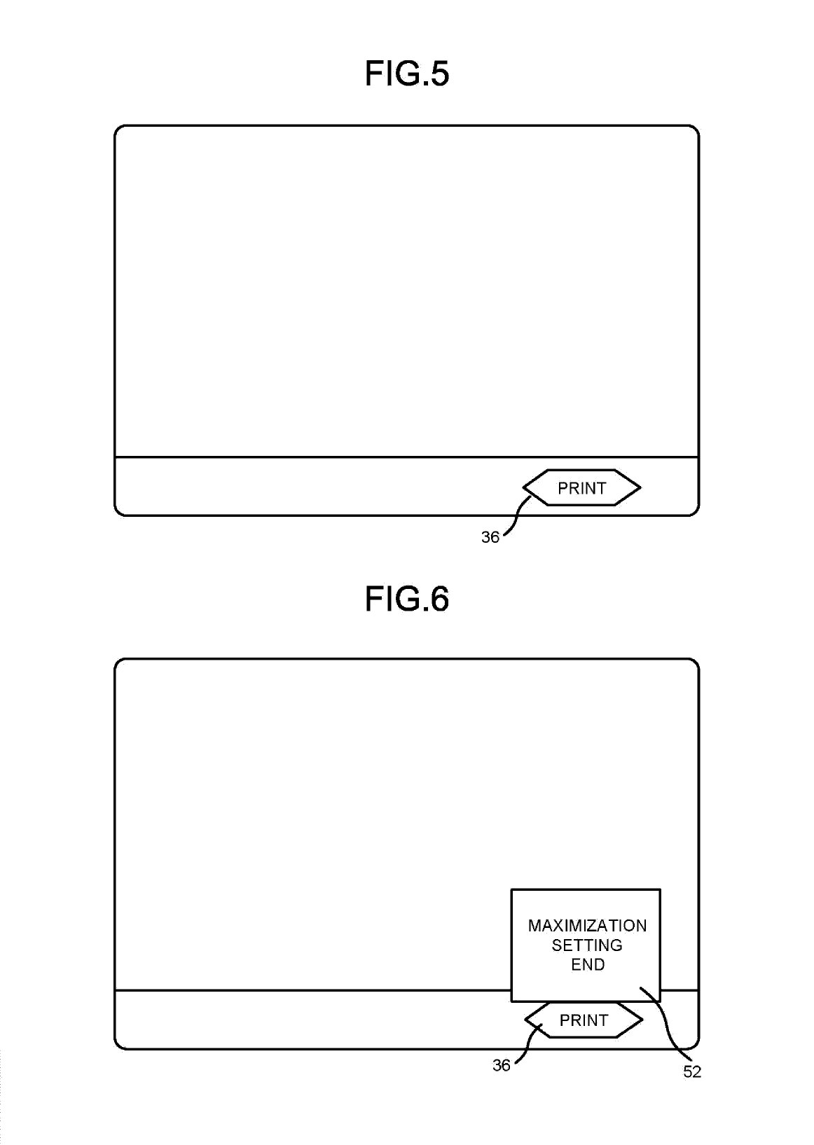

One example of the display of the switching tool icon 36 on the screen of the display section 18 is shown in FIG. 5. In this example, when the switching tool 28 is started, the switching tool icon 36 is always displayed at the right side of a taskbar 50 displayed at the bottom of the display screen.

Next, if the switching tool icon 36 is selected by, for example, right-clicking the switching tool icon 36, a menu dialog is displayed as shown by “52” in FIG. 6. In the present embodiment, the menu dialog 52 includes options such as “maximization”, “setting” and “end”.

The “setting” is a menu for selecting the setting processing in which various setting of the switching tool 28 is executed. The “maximization” means displaying the switching dialog 39 which will be described late. The “end” means ending the operations of the switching tool 28.

If the “setting” menu is selected in ACT A301, the control section 13 executes the setting module to start the setting processing. That is, the control section 13 controls the setting module 32 to display the setting dialog 38 (ACT A302). If other menu is selected in ACT A301, the processing corresponding to the selected menu is carried out (ACT A306).

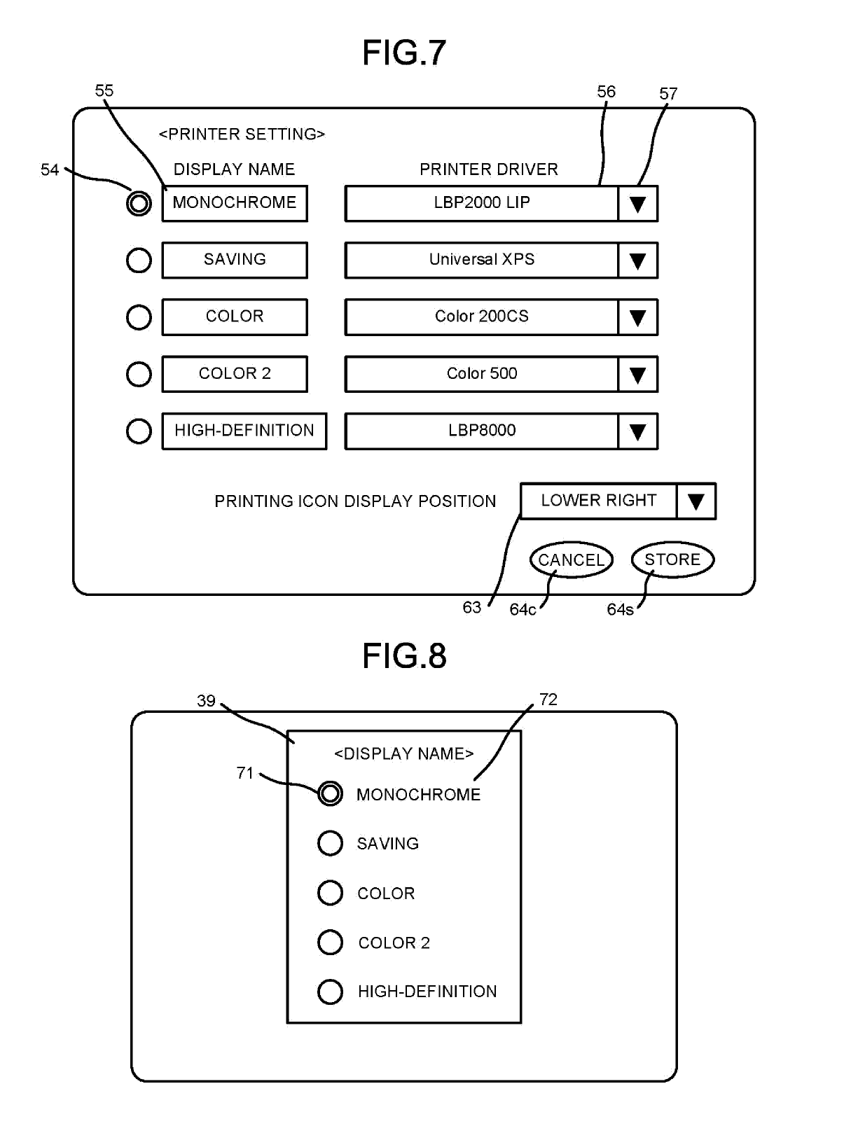

One example of the setting screen of the setting dialog 38 is shown in FIG. 7.

In FIG. 7, a user carrying out the setting operation selects a printer driver name 61, and inputs a display name of the printing to be carried out using the printer in a display name input column 55 of the printing (ACT A303).

The control section 13 executes the printer driver calling module 31, and acquires the information of the printer driver which is stored in the storage device 23 in an executable manner. The printer driver information is stored in, for example, the registry 27 of the storage device 23 shown in FIG. 1.

Further, the control section 13 may also execute the printer driver calling module when the switching tool 28 is started, and read the registry, thereby acquiring the printer driver information.

The setting dialog 38 includes, for example, a radio button 54, a display name input column 55 and a printer driver selection column 56, as shown in FIG. 7. The display name input column 55 is an area for a user to input any character. For example, the user can input a printing setting condition such as “monochrome”, “saving” and the like, or a lucid name matching with the printer to be used.

The printer driver selection column 56 displays the printer driver information acquired by the printer driver calling module, for example, a printer name. “57” represents a pull down menu, and if “57” is selected, a list of the printer drivers which can be selected in the printer driver selection column 56 is displayed.

The radio button 54 selects a default printer driver. The printer driver selected by the radio button 54 is in a pre-selected state when the switching module is executed.

For example, in FIG. 7, a printer driver “LBP2000 LIP” in which the “monochrome” is input is selected as an initial setting. The display position of the switching dialog 39 on the display screen of the display section 18 is displayed, in a selectable manner, in a column 63 at the lower side of the setting dialog screen. The switching dialog 39 is displayed on the display section 18 when the switching module is executed. The display position thereof includes four types of, for example, “always displayed at lower right”, “always displayed at upper right”, “always displayed at lower left” and “always displayed at upper left”.

In the setting dialog 38 shown in FIG. 7, a “store” icon 64s for storing the display name and the printer driver set in a way described above and a “cancel” icon 64c for canceling the setting are displayed at the lower side.

If the “store” icon 64s is selected (YES in ACT A304), the information set in the setting dialog 38 is stored in the tool registry 35. In this way, the display name input in the display name input column 55 is associated with the printer driver input in the printer driver selection column 56. The printer driver information is stored in the storage device 23 and then the setting processing is ended.

In addition, in the setting dialog 38 shown in FIG. 7, five printer drivers are set. However, the setting of the printer drivers is not limited to this. There is no need to set all the printer drivers as long as more than one printer driver is set.

In a case where the printer set in the setting dialog 38 is deleted from the OS after the setting, an error of, for example, “The selected printer is not found. Reset please.” can be displayed on the screen when the radio button of the switching dialog is selected.

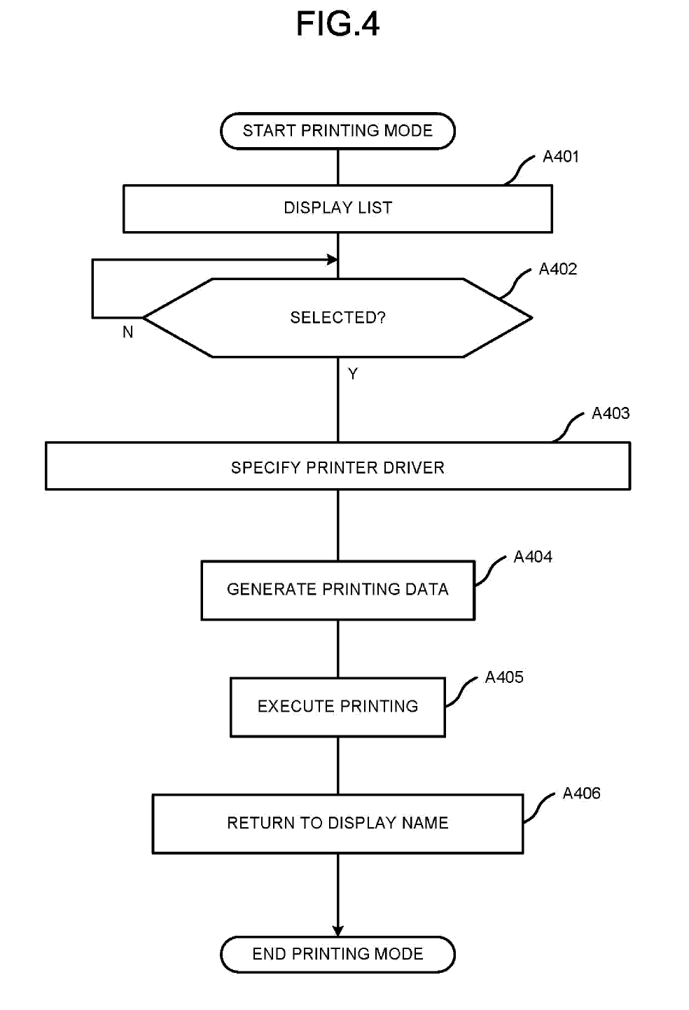

The printer driver switching processing based on the switching tool 28 is described based on the flowchart shown in FIG. 4.

When the setting processing in the setting dialog 38 is completed, or when the switching tool is started, or when the “maximization” menu of the switching tool icon is selected, the control section 13 executes the switching module 33 and displays, for example, the switching dialog 39 shown in FIG. 8.

The switching dialog 39 is displayed at the display position selected in the column 63 of the setting dialog.

The switching dialog 39 displays a selection section 71 for switching the printer driver and a display name 72. The display name 72 displayed herein indicates that the displayed characters input in the display name input column 55 on the screen (FIG. 7) of the setting dialog are the display name of the printing.

The selection section 71 is arranged for each display name in association with each display name. In the present embodiment, the selection section 71 is constituted by the radio button through which one printer driver can be selected from the candidates. In a case where the setting condition set in the setting dialog 38 is stored and the switching dialog 39 is started initially, the printer driver selected through the radio button 54 of the setting dialog 38 is selected. The switching module 33 reads the tool registry based on the polling for about each second and reflects the information in the display content.

Actually, the reading of value from the registry is only carried out when the switching tool 28 is started, and the acquired value is stored in a program such as the switching module, and the following reading can be carried out by reading the stored value. In this way, the workload can be reduced.

The control section (switching module 33) 13 reads the tool registry 35 when the module is started (the switching dialog 39 is displayed), and switches the printer driver stored as the initial setting as a “usually used printer”.

For example, even if the user sets a given printer driver A as the usually used printer in the printer setting of the OS, a printer driver B set in the switching tool 28 is changed as the “usually used printer” when the switching module 33 is started. That is, in a case of printing according to the application in the OS 26, when the unique printing dialog of the application is displayed, the switching tool becomes in a state in which the printer driver changed as the “usually used printer” is selected.

In ACT A401 in FIG. 4, the screen of the switching dialog (the screen shown in FIG. 8) is displayed. On this display screen of printing, the display names of printing input in the setting dialog shown in FIG. 7, that is, the “monochrome”, “saving”, “color”, “color 2” and “high-definition”, are displayed. It is detected which one of the printing types is selected by the user (ACT A402).

In ACT A403, the printer driver corresponding to the display name of printing selected in ACT A402 is specified. For example, if the “monochrome” is selected, the printer driver of “LBP2000 LIP” set on the screen shown in FIG. 7 is specified.

The printing data to be printed by the printer driver is generated (ACT A404). Then in ACT A405, printing is carried out using the selected printer driver.

In the present embodiment, as the detailed printing condition (for example, finishing conditions such as color/monochrome or duplex printing) applied when carrying out printing, the printing condition preset by the user as a default value for each printer driver is used.

If it is detected that the printing is ended, that is, the printing job is erased from the printing queue (printing ending), the control section (switching module 33) 13 returns such that the printer driver printing corresponding to the display name selected in the initial setting through the radio button 54 of the setting dialog 38 can be carried out (ACT A406). That is, the display name selected in the initial setting is switched to the state selected in the selection section 71 by the control section (switching module 33) 13.

Further, when returning to the printing of the initial setting after the printing is carried out, if the printer set in the initial setting is not found, the printing icon displays an error of, for example, “setting of valid printer is not carried out”.

As state above, in accordance with the present embodiment, the printer driver can be selected easily by selecting the display name of the printing created by the user himself who is to carry out printing, without being influenced by the display of the unique printing dialog of the application. The printing can be carried out easily and smoothly even if there are a lot of display names of the printing.

The display name of printing in the present invention refers to the name of the printing which is associated with a specific printer driver and is input by the user himself in the setting mode.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A computer-readable storage medium storing a program for causing a computer to execute a printer driver setting process, comprising:
displaying a display name of printing set in advance for each of a plurality of printer drivers which carry out printing; and
generating print data using the printer driver which is pre-set in association with the selected display name of printing, when one of the display names of printing is selected to execute printing.

2. The storage medium according to claim 1, wherein
in a printing setting mode, one of the display names of printing is associated with each of the plurality of printer drivers; and
in a printing mode, when one of the multiple display names of printing is selected, printing is carried out using the printer driver which is associated with the display name of printing selected in the setting mode.

3. The storage medium according to claim 2, wherein
in the printing mode, when a specific display name of printing is not selected, printing is carried out using the printer driver which is associated with the display name of printing set in an initial setting in the setting mode.

4. The storage medium according to claim 1, wherein
a user can input any characters as each display name of printing in the setting mode.

5. The storage medium according to claim 1, wherein
as to the association of each printer driver with the display name of printing in the setting mode and the printing in the printing mode, a switching dialog of display name of printing is displayed by clicking a switching tool icon displayed on a display screen.

6. A printer driver setting method, comprising:
displaying a display name of printing set in advance for each of a plurality of printer drivers which carry out printing; and
generating print data using the printer driver which is pre-set in association with the selected display name of printing, when one of the display names of printing is selected to execute printing.

7. The method according to claim 6, wherein
in a printing setting mode, one of the display names of printing is associated with each of the plurality of printer drivers; and
in a printing mode, when one of the multiple display names of printing is selected, printing is carried out using the printer driver which is associated with the display name of printing selected in the setting mode.

8. The method according to claim 7, wherein
in the printing mode, when a specific display name of printing is not selected, printing is carried out using the printer driver which is associated with the display name of printing set in an initial setting in the setting mode.

9. The method according to claim 6, wherein
a user can input any characters as each display name of printing in the setting mode.

10. The method according to claim 6, wherein
as to the association of each printer driver with the display name of printing in the setting mode and the printing in the printing mode, a switching dialog of display name of printing is displayed by clicking a switching tool icon displayed on a display screen.
